(19) United States
(12) Patent Application Publication
(10) Pub. No.: US 2003/0046184 A1
(43) Pub. Date: Mar. 6, 2003

(54) Electronic pen catalog ordering system and method of using the catalog to stimulate electronic pen use

(76) Inventors: Magnus Bjorklund, Spanga (SE); Rune Torbjornsen, Lidingo (SE)

Correspondence Address: BIRCH STEWART KOLASCH & BIRCH, PO BOX 747, FALLS CHURCH, VA, 22040-0747, US

(21) Appl. No.: 10/193,179

(22) Filed: Jul. 12, 2002

Related U.S. Application Data
(60) Provisional application No. 60/304,754, filed on Jul. 13, 2001.

(51) Int. Cl. G06F 17/60

(52) U.S. Cl. 705/26

(57) ABSTRACT

A system employs a code reading wand or digital pen to order items from a catalog employing item-identifying indicia which are preferably position-indicating indicia. The catalog includes items provided by plural suppliers. A single catalog order may be issued and distributed to plural suppliers by access to supplier information in a database. The catalog may be distributed with the code reading wand to promote initial use of the code reading wand and thereby aid in establishment of the technological infrastructure through immediate use of the wand. The catalog may include additional services to encourage the use of the catalog, thereby increasing catalog orders. The catalog service may be funded by charging suppliers a per order or inquiry, or periodic fee, based upon orders placed.

### BACKGROUND OF THE INVENTION

1. Field of the Invention

The present application is directed to a system for using a coded reading wand or electronic pen to order items from plural suppliers, and to a method of promoting the use of the electronic wand or digital pen through its association with a catalog, the catalog promoting the digital pen and associated services.

2. Background Information

The modern world relies increasingly on digital communication. Computers occupy a substantial role in a variety of modern activities and have enhanced both human productivity and access to information. The development of the internet, coupled with the development of modern communication technology such as wireless telephony, have further enhanced the transfer of information.

The computer era and use of computer technology has created several difficulties. Computers have generally forced their users to adapt the user's working methods to the requirements of the computer technology utilized. For example, typing or keyboarding has generally replaced writing as the preferred form of information recording. This has created the requirement that humans change their traditional working methodology to be compatible with digital technology.

Recently, the assignee of the present application has developed a new computer input device, a position indicia reading stylus or digital pen that allows the recording of information into a digital computing device by writing the information on paper, the paper being imprinted with a position defining background pattern. Thus, information may now be communicated electronically by writing the information while digitizing it, directly recording the information by writing, utilizing the user's handwriting. The pen may therefore record information written on the paper by the user, this information being recorded and processed by the pen and then provided by the system of the present application to an application provider which makes use of the recorded information to accomplish a desired one of a multiplicity of possible functions.

One possible function for such a digital pen is to perform catalog ordering. Heretofore, catalog ordering has been performed in a relatively simplistic fashion. Generally, a separate order is provided by each supplier, typically the catalog is accessed by accessing the supplier's website and placing an order to that supplier, providing each supplier with all necessary information.

It has been proposed in the past that ordering can be performed, in part, by the accessing of barcode indicia imprinted on a catalog, the barcode indicia being scanned to enter order information for ordering one or more desired objects from a supplier. However, no provision has been made to allow for the ordering of items from plural suppliers using a single order and ordering operation.

One problem associated with digital pen technology is that the pen technology has value that increases with the increasing number of users using such pen technology and increased traffic of the transmission of pen data. As pen use increases, the cost of providing such services becomes increasingly manageable. For this reason, the adoption of such a technology with at least a threshold market penetration is desirable in order to ensure sufficient use to support the technology and to ensure a reasonable profit to both the technology service providers, those providers providing technology based services (e.g. pen data lookup services in the context of the present application) and technological infrastructure providers, those providers of the hardware needed to implement the technology (e.g. pen and paper suppliers in the context of the present application). For this reason, it is desirable to take active steps to encourage initial use of the digital pen technology, providing the digital pen owner with sufficient applications for the technology to encourage the acquisition and use of digital pens, increasing the number of digital pens in service and the amount of traffic of digital pen-related messages.

### OBJECTS AND SUMMARY OF THE INVENTION

It is accordingly an object of the present invention to provide a digital catalog ordering system and method which enables a code reading wand or digital pen user to order or inquire about items (goods or services) from plural suppliers with a single catalog order data transmission.

It is further an object of the present invention to promote the use of the code reading wand or digital pen by distributing a catalog, in association with the distribution or sale of the code reading wand or digital pen, thereby providing the user with an application which promotes the use of the code reading wand or digital pen.

It is a further object of the present invention to add additional functionality into the catalog provided with position-defining indicia, in order to increase the usefulness of the catalog to the code reading wand or digital pen user, thereby increasing the likelihood that the catalog will be retained and referred to by the user. Such additional functionality would typically be functionality provided without charge, with the exception of per use or periodic wand or pen service or use charges, this functionality being offered to the user to encourage the user to refer to the catalog, causing the user to retain the catalog, and thereby increasing the likelihood that the customer will make inquiries or orders for fee-based goods or services, due to retention of the catalog.

It is a further object of the present invention to finance the generation of such a catalog by charging advertisers a per order inquiry-based fee, which fee may be related to wand use time, sales dollar volume, or any other criteria related to the order generated through the publication of the catalog.

In accordance with the teachings of the present application, a catalog system is provided which receives order information including at least information identifying the code reading wand or digital pen and order particular information, the ordering information or at least a part of the ordering information being routed by the database to one or more of plural suppliers advertised in the catalog. In other words, in accordance with this aspect of the invention, the fee-based items listed in the catalog are associated with plural suppliers, the system of the present application routing appropriate parts of the information pertaining to a single order to the appropriate supplier or suppliers to enable shipment of the items directly from the supplier to the customer.

In accordance with another aspect of the present invention, a catalog is provided in association with the sale or distribution of the code reading wand or digital pen. This provides the acquirer of the code reading wand or digital pen immediate functionality of the pen, the user or customer being able to order goods or services from the pen. Desirably, additional services that are not provided on a fee basis, other than code reading wand or digital pen related service fees, are provided, these additional services further increasing the functionality of the pen, encouraging the customer to retain the catalog, increasing the likelihood that the catalog will be later referred to and additional orders will be made.

As an additional aspect of the present invention, the funding of catalog preparation may be financed by fees acquired from the advertisers. These fees may be either charged in advance, or charged on a per-order inquiry basis, either at a fixed rate, a rate based upon the cost of the goods or service ordered.

The above-presented objects and summary highlight exemplary aspects of the present invention, but do not reflect all of the features of the present invention and thus are not determinative of the full extent of the invention.

### BRIEF DESCRIPTION OF THE DRAWINGS

The accompanying drawings are incorporated in and constitute a part of this specification and together with the detailed description, describe the principles and features of the present invention, wherein:

FIG. 1 is an exemplary diagram illustrating the interaction between a digital pen employed by an individual end user, the technological service provider or digital pen look-up server, and the application service provider;

FIG. 2 is an exemplary flow chart illustrating schematically one possible function of such a digital pen, the transmission of an SMS message from a user via a network to a recipient;

FIG. 3 illustrates one embodiment of the catalog ordering system of the present application, wherein a digital pen is utilized to provide order information to plural suppliers. In the embodiment of this figure, the order information is provided directly to plural suppliers, the routing of this order information being provided from the digital pen via a digital pen look-up server provided by the digital pen or technological service provider;

FIG. 4 illustrates an alternative embodiment of the catalog order system of the present invention in which the catalog order acquired by the digital pen is routed to a catalog server by the digital pen look-up server, the catalog server then routing appropriate information to individual suppliers;

FIG. 5 is a perspective illustration of one form of code reading wand-supported catalog displaying plural services provided by plural service providers;

FIG. 6 is an exemplary alternative catalog page in which additional services free to the user apart other than any cost of the wand use services are provided in addition to catalog order or inquiry services;

FIG. 7 illustrates the application of the principles of the present application to a position-defining indicia-bearing magazine employing the catalog principles of the present invention;

FIG. 8 illustrates another exemplary image of a catalog made according to the present invention, the catalog illustrating the alternative use of code reading wand-stored information or customer-added information, to specify customer-specific information needed for an order;

FIG. 9 is an exemplary page illustrating the possible addition of additional service functionality to a catalog produced in accordance with the teachings of the present invention, which additional functionality or services will encourage retention of the catalog by the user, enhancing the likelihood of later order of fee-based goods or services; and

FIG. 10 is an exemplary catalog page illustrating a combination of such additional services and inquiries about fee-based services. Additionally, FIG. 10 illustrates the ability to substitute a desired address from the address specified by the digital pen.

### DETAILED DESCRIPTION OF EMBODIMENTS

The detailed description presented hereinbelow and referring to the accompanying drawings illustrates exemplary embodiments of the system and method of the present application. It should be noted, however, that while these embodiments are exemplary and include those modes preferred by the inventors, the scope of the present application is defined solely by the appended claims.

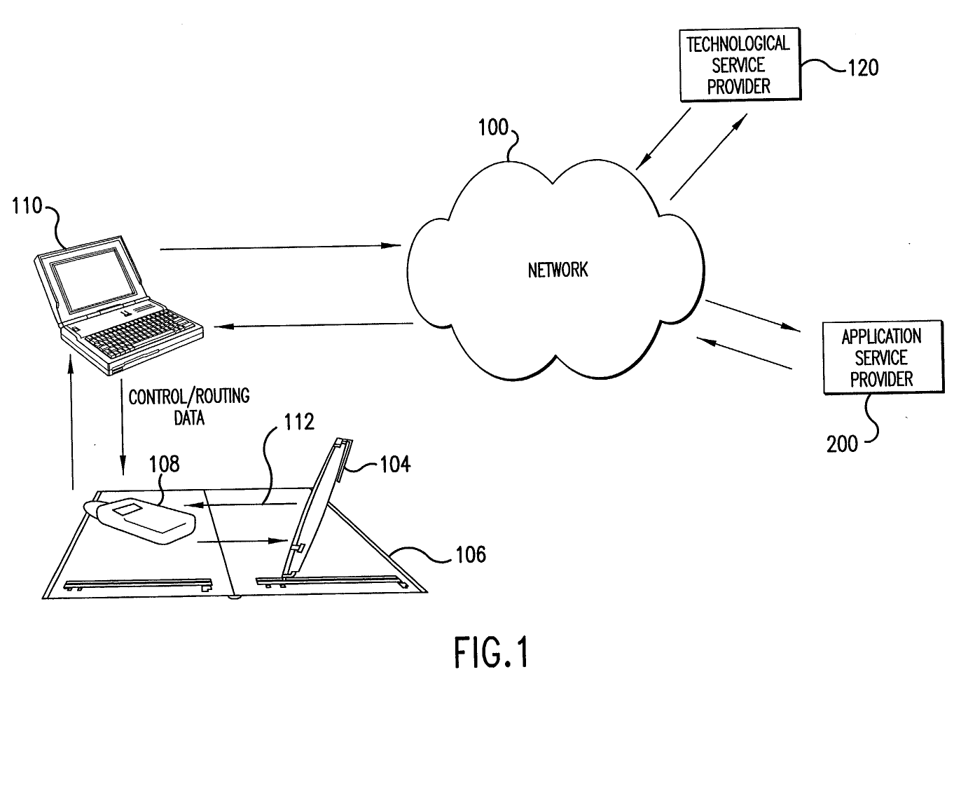

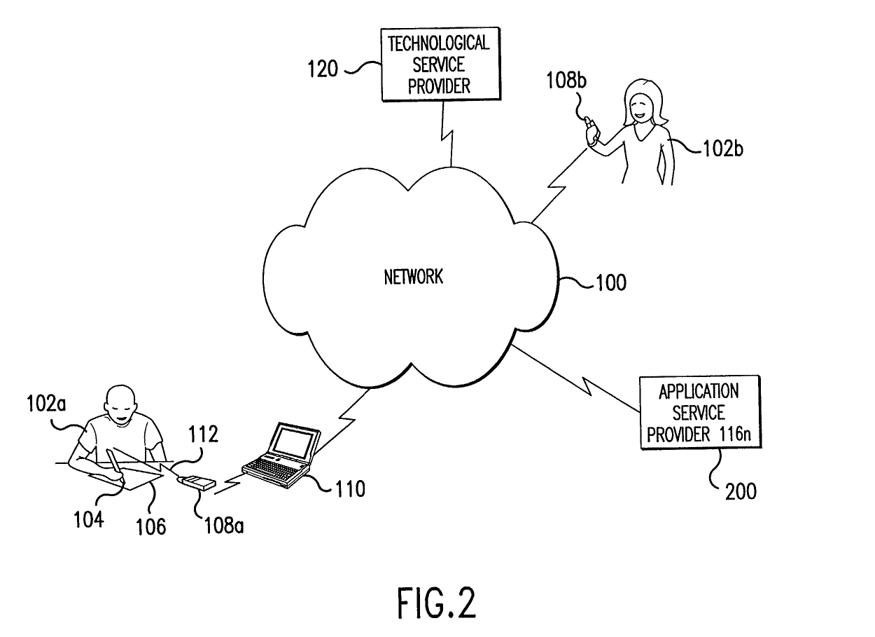

In accordance with the digital pen techniques generally employed and described in the applications mentioned herein, a network environment may interact with individual end users 102a, 102b as illustrated in FIG. 2. These individual end users may employ a position indicia reading stylus such as a digital pen 104 to create messages by writing on a surface having a position defining background pattern imprinted thereon, such as digital paper 106. The digital pen 104 is connected to a communication channel. In the embodiments of FIGS. 1 and 2, the pen is connected to a wireless telephone 108 that is a part of the communication channel, via a pen-communication channel connection 112, that in the preferred embodiment, is a signal encrypted in accordance with a Bluetooth communication protocol.

The Bluetooth enabled wireless telephone 108 may then communicate with a personal computer 110, or alternatively, may communicate directly with a wireless telephony infrastructure in order to communicate information to the technological service provider 120 that typically includes a digital pen look-up server. The digital pen look-up server verifies the pen account information and routes communications from the digital pen to an application service provider 200. A digital pen system in accordance with the teachings of the present invention may include any number of individual end users 102a, 102b of FIG. 2, as well as plural technological service providers 120 and plural and/or diverse application service providers 200. Alternatively, the digital pen 104 might communicate directly with a Bluetooth access point and then via the internet or other communication channel.

FIG. 1 illustrates one example of a digital pen that communicates with an application service provider to perform a desired function. The digital pen 104 may be associated with an individual or business end user. End users may utilize the digital pen and digital paper for a variety of purposes. For example, writing from a digital pen on digital paper may be transformed to a facsimile message, an electronic mail (e-mail) message, or a short message (e.g., SMS-short message service). The message may then be routed to an appropriate destination, which may be known from the application or which may be indicated in the pen enabled writing. The digital pen 104 includes a sensor for reading position from the digital paper, and some structure for communicating this information to the desired destination. The pen may be hard wired, provided with infrared base communication technology or in one preferred embodiment, may communicate to a communication channel for eventual transfer to the desired destination via a pen-communication channel connection 112 which may desirably employ wireless data transmission utilizing the Bluetooth communication protocol.

In the example in FIG. 1, the digital pen 104 communicates information via a Bluetooth encoded wireless transmission 112, to a Bluetooth enabled wireless telephone or PDA (personal digital assistant) 108 which may save the data and then, in turn, transmit the data to a personal computer 110 connected to a communications network such as the internet.

The digital paper 106 is coded with position-defining indicia which may be read by the digital pen, the position-defining indicia preferably being a position-defining background dot pattern. The digital pen 104, when pressed to the digital paper 108, records pen position as the pen traces any desired pattern under control of the user, the pen being provided with an ink dispenser, so that the user may perceive the recorded information as writing or drawing from the ink trace.

The digital pen records the information and, upon user command, transmits the information via the communication channel 108 to a digital pen look-up server provided at the location of a technological service provider 120. In the embodiment of FIG. 1, the communication channel includes the wireless telephone, a personal computer 110, and the internet connection to the digital pen look-up server of the technological service provider 120.

The pen transmits a pen identifier identifying the digital pen transmitting information to the technological service provider 120, and a request for identification on where to transmit pen stored data read from the digital paper. The technological service provider 120 verifies that the digital pen is associated with a current account, and then transmits the digital pen the location of an application service provider 200. The identification of the application service provider may be desirably dependent on several factors.

Firstly, the digital pen 104 may recognize the type of application to which it is being applied, by recognizing the position-identifying indicia of the digital paper 106 as unique to a particular template. For example, different templates may be used for facsimile messaging, electronic mail messaging, catalog ordering or inquiry, or requesting of additional information such as stock information or the like. Based upon the position-defining indicia imprinted on the digital paper 106, the digital pen provides the technological service provider 120 with an identification of the template being used, as identified from the digital paper. Based upon that template, as well as other factors such as user location and technological service provider location, the technological service provider provides the digital pen with the address or location of the application service provider 200 by, for example, providing an internet protocol (IP) address.

The digital pen then transmits information relevant to the application to the application service provider. For example, if the application service provider is a facsimile server, a data stream defining the position data encoded by use of the digital pen is provided to the application service provider with instructions on where to send this information, such as a facsimile number.

The digital pen may desirably have character recognition software encoded therein. The template may desirably recognize that certain locations on the digital paper are to be processed with character recognition software, to provide a recognizable e-mail or facsimile address. This e-mail or facsimile address may be supplied to the application service provider or, alternatively, the optical character recognition may be performed at the application service provider. Of course, although the embodiment of FIG. 1 specifically illustrates only a single set up of an individual end user, a single technological service-provider 120 and a single application service provider 200, many such users and providers may be arranged on the network environment 100.

Although the above description is based upon a consumer use, there may be business end users as well. For example, a business end user might employ a digital pen-based inventory system, for transmitting delivery status to an application service provider 200, which would be an inventory control host computer.

The digital paper 106 may be ordinary paper imprinted with the unique proprietary pattern. A very small portion of the pattern may be associated with a uniquely defined function, such that when the pattern portion is detected by a digital pen, the associated function may be implemented. The pattern desirably includes small dots with a nominal spacing which are slightly displaced from a grid structure. As a customer writes on the digital paper using the digital pen, the pen takes periodic snapshots of the pattern and then, from the pattern, decodes pen position. This information can be stored or processed in the pen or may be forwarded to the technological service provider 120 that may perform a mapping service on this data.

The complete addressable area of the full pattern may be divided into numerous domains, each of which is related to a different application. Thus, when the position of the digital pen on the pattern is noted, the pattern position may indicate the type of paper being read, identifying the paper or form being utilized, the template. As used herein template refers not only to template information but also to information related to where on a position space defined by the position-identifying indicia identifying the position that template information is located. The same basic template information can be, for example, used by different advertisers, by associating the template information with different locations defined by the position-identifying indicia. This, for the purpose of this application, is considered different templates. The digital pen preferably includes an ink dispenser, which ink is preferably transparent to the camera provided in the digital pen.

FIG. 2 illustrates individual end users 102a and 102b arranged around a network environment 100 including a technological service provider 110 and application service provider 200. As an example of the operation of the system employed in accordance with the teachings of the present application, the first individual end user 102a may utilize his digital pen to write a message on digital paper 106 intended for either facsimile, e-mail, or SMS transmission. The user may tick a box on the paper which box indicates that the message should be sent via SMS. The user then ticks a send box and the digital pen contacts the technological service provider 120 via the communication channel, the digital pen 104 transmitting information via the Bluetooth communication protocol to the first user's wireless telephone 108, which in turn communicates the information to the first user's personal computer, where the information is then transferred via a network environment 100 such as the internet to the technological service provider 120.

The technological service provider 120 verifies that the pen user is an authorized user with a current account and then sends the pen 104 of the pen user 102a the address of the application service provider 200, in this case an SMS server. The digital pen 104 then transmits the SMS message to the application service provider 200. The application service provider 200 then directs the SMS message to the second individual end user 102b where the message appears on that user's mobile telephone 108b. Translation of the position information encoded in the digital pen 104 can be performed in a number of locations. The digital pen 104 may desirably perform some translation functions, or these translation functions may be contained within the wireless telephone 108 or associated personal computer 110. Alternatively, translation functions such as the recognition of unique codes defined by the ticking of boxes, may be performed by the technological service provider 120, or may also be performed by the application service provider 200. However, the ultimate result is the transmission of the address of the recipient 102b and the SMS data to the application service provider 200 where the data is forwarded to the second end user 102b in the normal fashion.

It should be understood that the digital pen 104 may communicate information to the technological service provider 120 or digital pen look-up server and application service provider 200 over any suitable communication channel. In the preferred embodiment, the digital pen will utilize the Bluetooth wireless communication protocol to transmit information to a wireless telephone, PDA, or Bluetooth-enabled computer. However, the digital pen 104 could be wired to a computer. The remaining portions of the communication channel may be wired or wireless telephone lines, internet, intranet, or any suitable combination of available communication techniques.

Having described the generalities of the digital pen technology employed in the present application, Applicants will now describe the specifics of the catalog ordering system utilized herein.

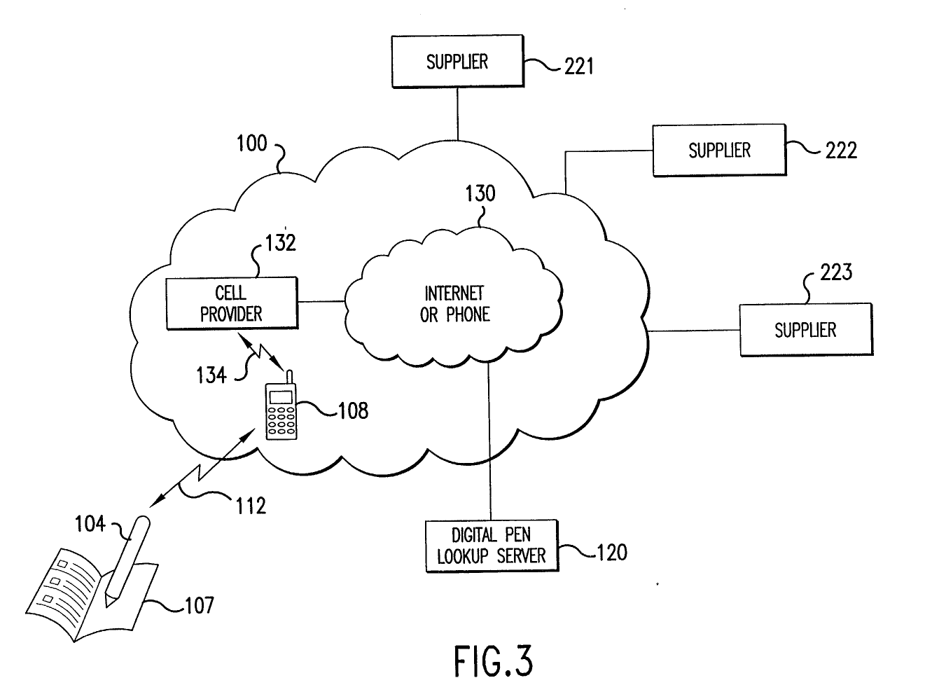

In the embodiment of FIG. 3, the digital pen 104 interacts with a catalog 107 containing item identifying indicia which are preferably position-defining indicia identifying specific products to be ordered. While the catalog would typically be prepared from paper, any suitable material containing item identifying indicia may be utilized. The digital pen communicates via a pen communication channel connection 112, such as a Bluetooth-enabled transmission, to a network environment 100. In the example of FIG. 3, the pen communicates to a Bluetooth-enabled wireless telephone 108, which provides pen data to the digital pen look-up server 120 and a plurality of application service providers, in this case catalog item suppliers, 221-223. In the example of FIG. 3, the cellular phone 108 communicates wirelessly to a cellular provider 132 which in turn communicates information via the internet or via telephone lines 130 to the digital pen look-up server 120 and relevant application service providers, in this case item suppliers 221-223.

Although catalog ordering via barcoded data or the like has been known, such catalog systems heretofore have been designed for implementation by a specific catalog vender. As such, such catalog order systems may not readily be adapted to situations where plural item suppliers have items identified in a single catalog for ordering by the customer.

In accordance with the teachings of this example of the present application, the digital pen look-up server 120 retains information identifying the location of the supplier for each good or service (item) advertised in the catalog. Thus, for example, when a catalog order is made by checking several boxes related to several ordered goods or services, and when the send or order box is ticked, the digital pen transmits an inquiry to the digital pen look-up server 120. In the example of FIG. 3, this inquiry will include not only the identification of the pen and the identification of the catalog via digital paper functionality, but will also include information about the boxes that are ticked, which may be used by the digital pen look-up server 120 to identify the suppliers to which those orders may be routed. The supplier location information (e.g. I.P. address) associated with each item ordered is then transmitted by the digital pen look-up server 120 back to the digital pen 104, where it is used by the digital pen 104 to route the order-specific information to each of the plural suppliers 221-223. Since more than one supplier is related to the catalog, the system and method must identify the supplier of each item and provide that supplier with supplier specific order information, enabling one or more than one of the suppliers to be advised of the order while the consumer transmits only a single order, even if filled by plural suppliers 221-223.

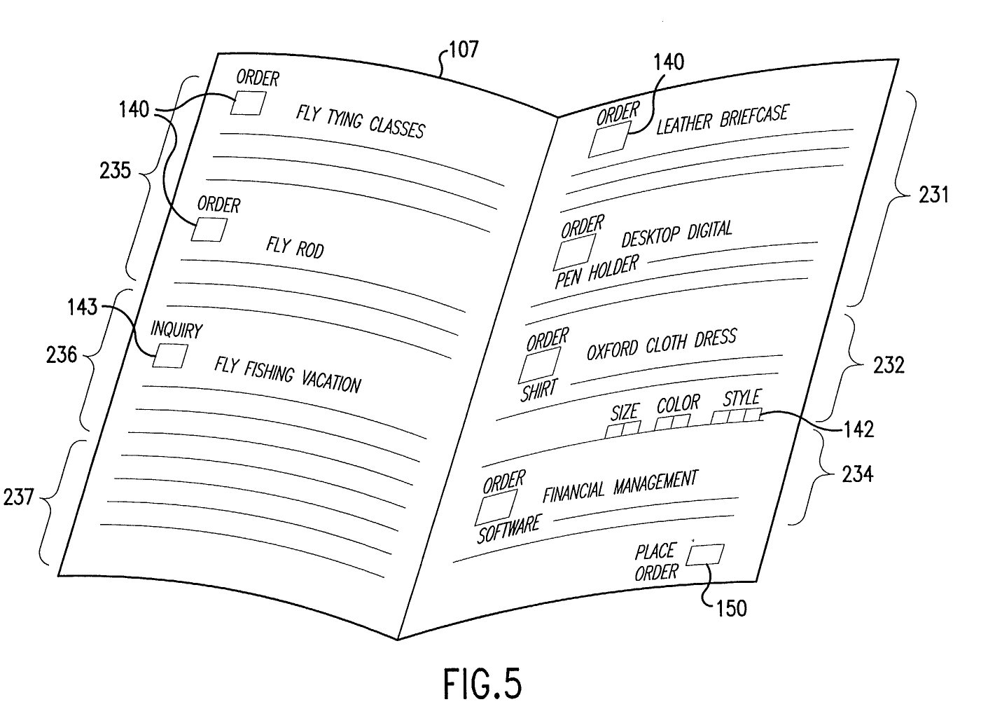

This example may be best understood with reference to FIG. 5. FIG. 5 illustrates an example of the catalog 107. In this catalog, diverse items are offered. For example, a leather briefcase and desktop digital pen holder are office goods or items 231 advertised and supplied by a first supplier 221. Oxford cloth dress shirts are clothing goods or items 232 offered from a second supplier 222. Note that each item to be ordered may be provided with an order box 140 to be ticked by the digital pen to indicate order of that good or service. In the instance of the oxford cloth dress shirt, a clothing item 232, it is desirably necessary to indicate size, color and style and additional detail boxes 142 are provided therefore. If the customer elects to order oxford cloth dress shirts, the customer may write or tick a desired field 142 to identify size, color, style, or other data relevant to the order.

A third supplier 223 may provide financial management software, a software good or item. Similarly, a fourth supplier (not shown) may advertise a fourth set of goods, for example, fly-tying classes, and a fly rod, recreational goods and services (items) 235. Similarly, each item advertised in the catalog 107 need not be ordered from the catalog. Instead, an inquiry for additional information my be issued. For example, the fly fishing vacation, a service item 236, may be difficult to order by simply ticking an order box 140. In such a case, an inquiry box 143 may be ticked to inquire or request additional information about this item. The catalog may desirably also include text 237 to engage the catalog reader and encourage catalog use.

In the event the customer elects to order fly-tying classes by ticking the box 140 associated therewith and the financial management software 234 by ticking the order box associated therewith, and then the customer ticks the place or send box 150. The digital pen sends a transmission to the technological service provider or digital pen look-up server 120. In the embodiment of FIG. 3, the technological service provider or digital pen look-up server responds to this inquiry containing identification of the order boxes to provide the digital pen used by the customer with information as to where to send supplier-specific portions of the order. Thus, the address of the third supplier 223 would be supplied since, in this example, if financial management software is ordered, while the address of the supplier supplying the fly-tying classes and fly rod would be supplied to the pen to facilitate that order specific information.

As an alternative, no send box need be used. In this embodiment, each service or good selection box (e.g. box 140) when selected causes the digital pen 104 to record a good or service order message. Then, when the digital pen transmits a Bluetooth encoded message to a communication channel, the digital pen lookup server 120 will return to the digital pen 104, supplier specific order information related to that specific supplier for each individual order and the digital pen 104 will transmit order specific information related to the goods or services identified by ticked box 140 to the supplier along with customer-specific information as will be described. Alternatively, the digital pen transmission associated with the order identified by box 140 may be translated and forwarded by the digital pen lookup server 120 to be forwarded directly to the supplier. Plural messages will be sent if plural goods/services are to be ordered.

In this way, the digital pen look-up server provides the digital pen with information needed to transmit different supplier-specific order information to each of the relevant suppliers from the single order. The digital pen then transmits customer-specific information identifying the customer, typically stored in the digital pen including shipping, billing, telephone and credit card information, as well as any supplier specific order information for that part of the order.

Optionally, a personal identification number (PIN) identifying the pen user and authorizing the transaction may be required. The PIN may be entered by the mobile telephone or computer or by writing the number in a specified location on the digital paper. Alternatively, a signature may be required on a signature field.

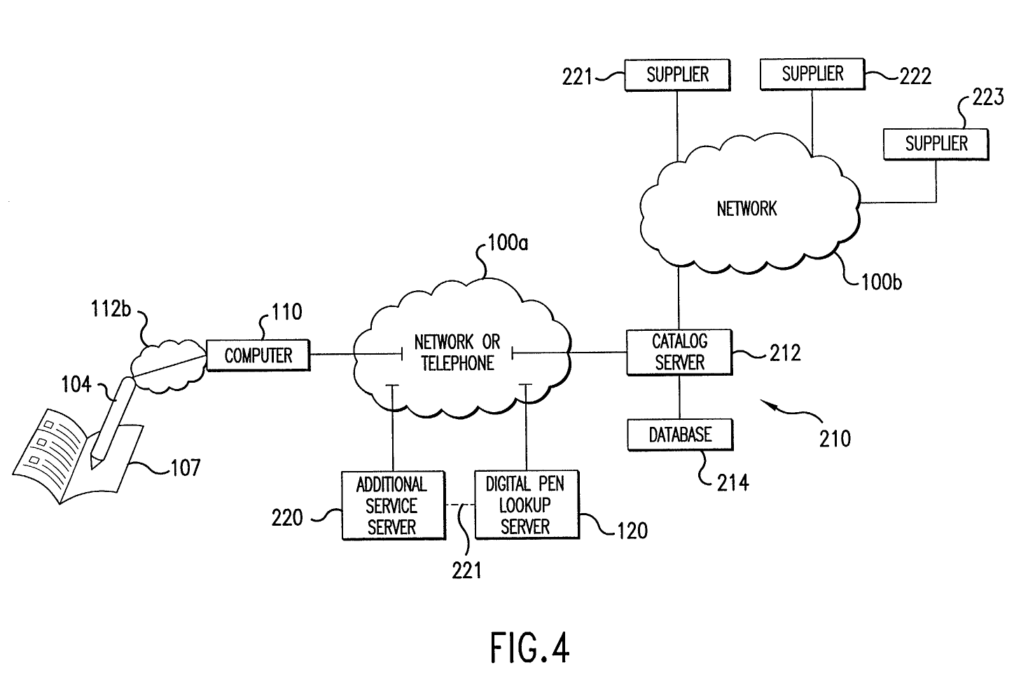

FIG. 4 illustrates an alternative embodiment to FIG. 3 wherein an intermediate catalog server 212 is provided as a type of application service provider 200. In the embodiment of FIG. 3, each supplier 221-223 was treated as an individual application service provider, the digital pen lookup server providing the digital pen with supplier address information to route the various supplier-specific order information to each of the suppliers from the digital pen in cooperation with the customer-specific information. However, in FIG. 4, the digital pen look-up server 120 routes the entirety of the order to an application service provider 200, in this case intermediate catalog server 212.

Thus, using the same example mentioned above with reference to FIG.3, when the customer ticks the place order box 150, the digital pen 104 communicates a request to the technological service provider or digital pen look-up server 120, which is evaluated to ensure that the account is current and then the digital pen look-up server 120 transmits the address of the catalog server 212 back to the digital pen 104. The pen transmission to the digital pen lookup server 120 identifies the template of the particular catalog. The digital pen lookup server therefor provides the pen 104 with the address of the catalog service provider 210 associated with the catalog 107. Note that different catalogs may correspond to different catalog service providers 210 as identified by the position identifying indicia of the individual catalog.

The digital pen 104 then transmits the recorded catalog order to the catalog server 212 identified by the provided address. The catalog server 212 utilizes a catalog server database 214 to identify the location of each of the suppliers 221-223 and to divide the order received from the digital pen 104 into plural supplier-specific orders, sending the information to the individual suppliers 221-223 over a network environment 100b, so that the suppliers may supply the order directly. In this fashion, an indicia-scanning wand device may place a single order for plural goods or services, from plural suppliers.

In the FIG. 4 embodiment, note that the digital pen 104 is hardwired to the computer 110 via a pen communication channel connection. The computer 110 is then connected to the digital pen look-up server or technological service provider 120, and the catalog service provider 210, one of plural application service providers 200 of FIGS. 1, 2, via a first network environment 100a. While networks 100a, 100b may be a common network, they need not be. It should be apparent from this figure that the nature of the communication channels may be adapted to the desired situation in any manner which would occur to one of ordinary skill in the art.

As mentioned in the Background of the Invention section of the present application, one objective of digital pen-based catalog advertising is to increase initial digital pen usage. In accordance with the teachings of the present application, the catalog may be desirably offered in association with the sale or distribution of the digital pen. Alternatively, the catalog may be included with the sale of digital paper having another functionality, such as SMS paper or the like. The catalog may be included within the sales packing of the digital pen, may be handed out at the store selling the digital paper, may be provided the customer upon receipt of a warranty card, or may be provided as a periodically generated magazine, offered in association with the sale of the product.

The sales catalog provides the user of the digital pen with initial functionality with which to use the digital pen, the additional functionality encouraging the use of the pen, increasing periodic pen use revenue to the technological service provider, and familiarizing the user with the use of the digital pen. Thus, incorporation of the catalog with the pen upon pen distribution may significantly increase pen usage and general success of the technological infrastructure required to implement the use of such digital pens. It should be noted that the marketing scheme employed to market digital pens may desirably be targeted to a segment of the consumer population, and the catalog may be desirably tailored to that segment of the population, with goods and services of particular interest to that segment of the population. For example, in the example of FIG. 5, business users may have particular interest in briefcases, dress shirts, financial management software, and leisure activities such as fly fishing.

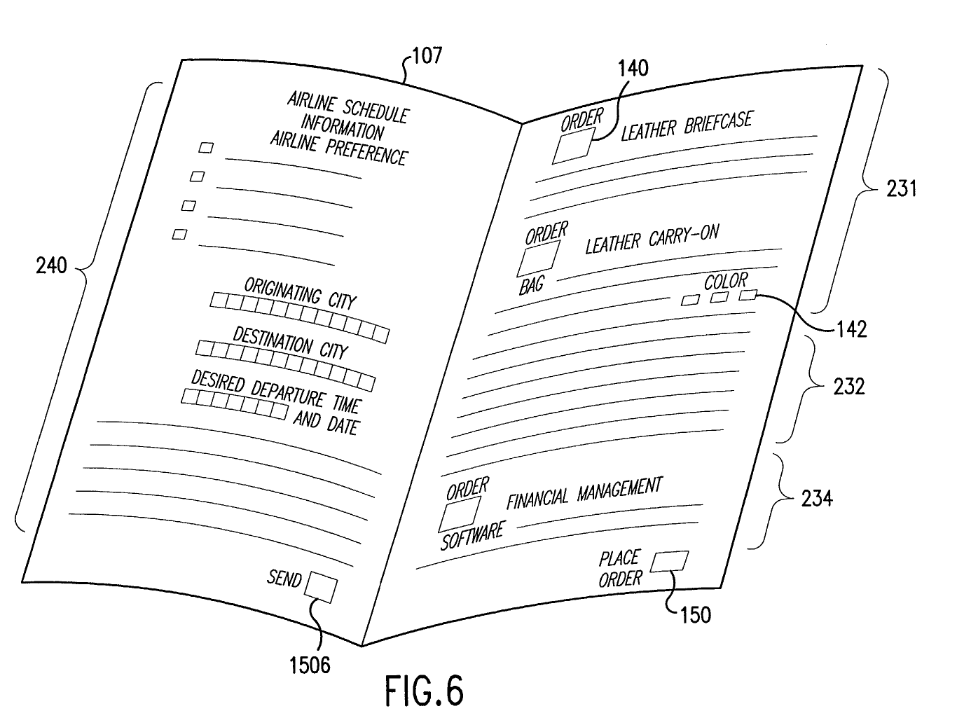

One problem associated with the distribution of a catalog is that the customer may review the catalog once and if there is no product of immediate interest, may lay the catalog aside or discard it. Even if the catalog is not discarded, the user may have trouble locating the catalog at a later date, should the user decide to order an item. In order to increase the chances that the catalog will be maintained in close proximity to the user, thereby increasing the likelihood of orders being placed, the catalog may desirably include additional functionality not primarily associated with advertised items (goods and services). FIG. 6 illustrates an example of such a catalog wherein airline schedule information is included within the catalog. In this manner, should the customer be interested in the flights available between two cities, for example, Los Angeles and Chicago, the user may list the cities, the desired departure time and date, the preferred airline, and inquire about available schedules. An additional service server 220 with an associated additional service database may be employed. Desirably, this additional service server 220, a form of application service provider 200, may be provided without a fee additional to the per-use or periodic digital pen services provided by the digital pen look-up server.

The digital pen look-up server 120 may either treat the additional service server 220 as a separate application service provider, communicating to the digital pen to route the airline schedule request to the additional service server 220, or the digital pen look-up server 120 may connect directly to the additional service server 220 via direct connection 221. In any event, by including additional functionality in the catalog, the customer is encouraged to retain the catalog and refer to it periodically. In this manner, the value of the offered advertising related to the fee-based goods and services is substantially enhanced through continuing referral to the catalog and request for additional services. There is also a likelihood that the pen based services will be used more frequently.

In the example of FIG. 6, the airline schedule information portion 240 of the catalog is activated by ticking the send box 150b, which causes the digital pen look-up server 120 to route the request to the additional service server 220 where the requested information can be either downloaded to the customer's mobile telephone via SMS messaging, PDA, or personal computer. Alternatively, any desired manner of transmitting the desired information to the customer, such as facsimile or the like, may also be utilized.

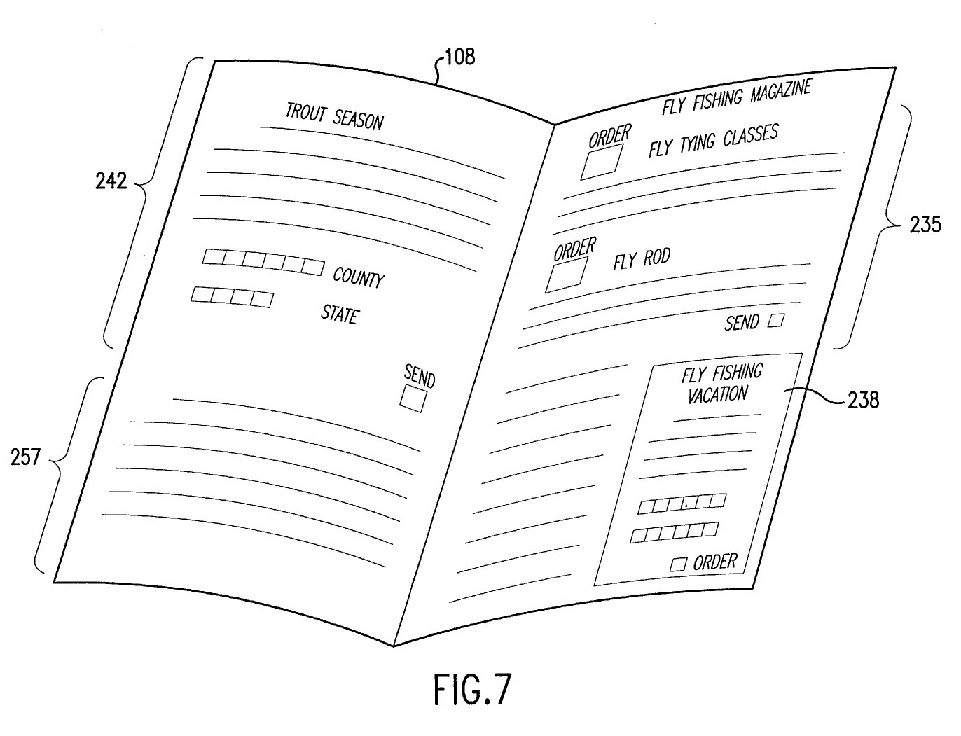

FIG. 7 illustrates an additional example of a catalog. FIG. 7 illustrates the use of a periodic magazine 108 which includes not only items to be offered (ordered or inquired about) but also relevant articles to the reader such as text 237, and provision for additional information requests 242. In this case, the additional information request 242 is a request for the effective dates of the trout season and a particular locality. This additional service is of particular relevance to a fly fishing enthusiast, and might be provided in association with an offering to fly fishing enthusiasts. In any event, FIG. 7 illustrates the possibility that the catalog be incorporated within a magazine or periodical. Additionally, FIG. 7 illustrates the possibility that the magazine included a separate advertisement 238, unrelated to the rest of the order, and routed separately by the digital pen look-up server 120.

The advertising services offered by the catalog 107 to be provided with the initial sale or distribution of the digital pen 104 are equally applicable to any indicia-scanning wand-based system. Such advertising enhances the functionality of the digital pen or wand 104 and will contribute to the pen's success. However, preparation of such a catalog or periodical may be a costly undertaking. In order to defray the cost of such a catalog, publication or printing fees may be obtained from the individual suppliers 221-223 at the time of catalog preparation. Alternatively, and perhaps desirably in accordance with the teachings of the present application, the suppliers 221-223 may be charged a per order or per inquiry fee which may be either related to the amount of digital pen service provided, or alternatively, may be a percentage of the sales price of the good or service offered. For example, the supplier may be charged 15 or 20% of the sales cost of the product for lower cost items, but may be charged a much lower fee, perhaps less than 1%, of higher cost items such as automobiles. In this manner, the catalog publication and distribution services may be charged to the suppliers on a per order or inquiry basis and may actually develop into a profitable use of digital pen based services performed by look-up server 120 or catalog server 210.

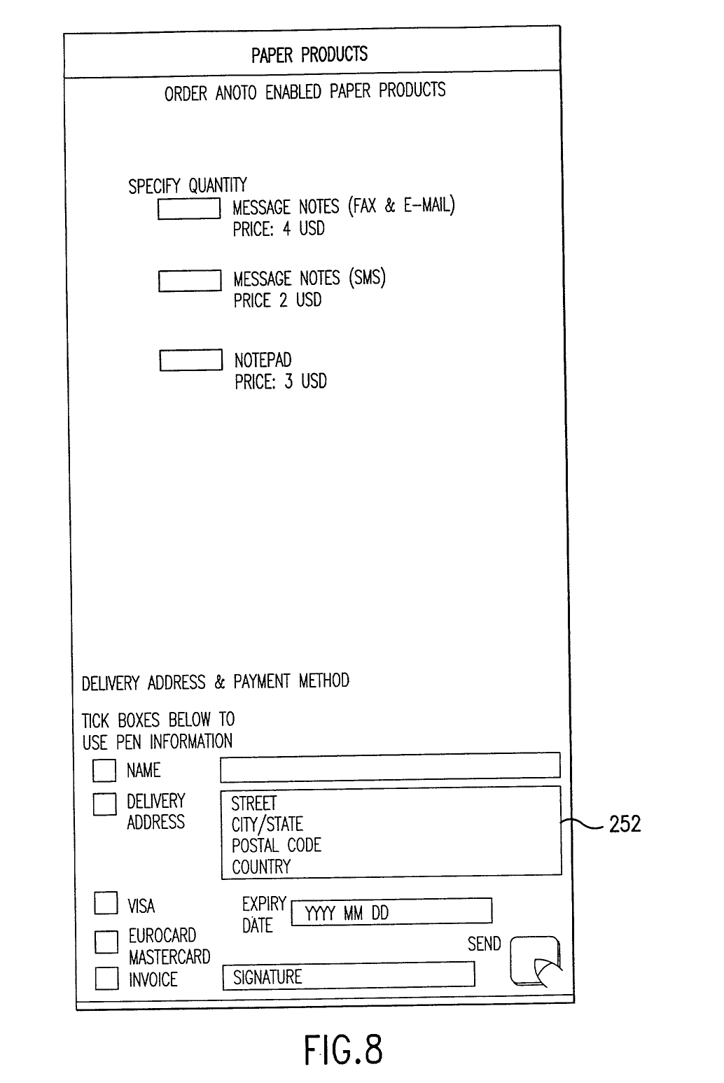

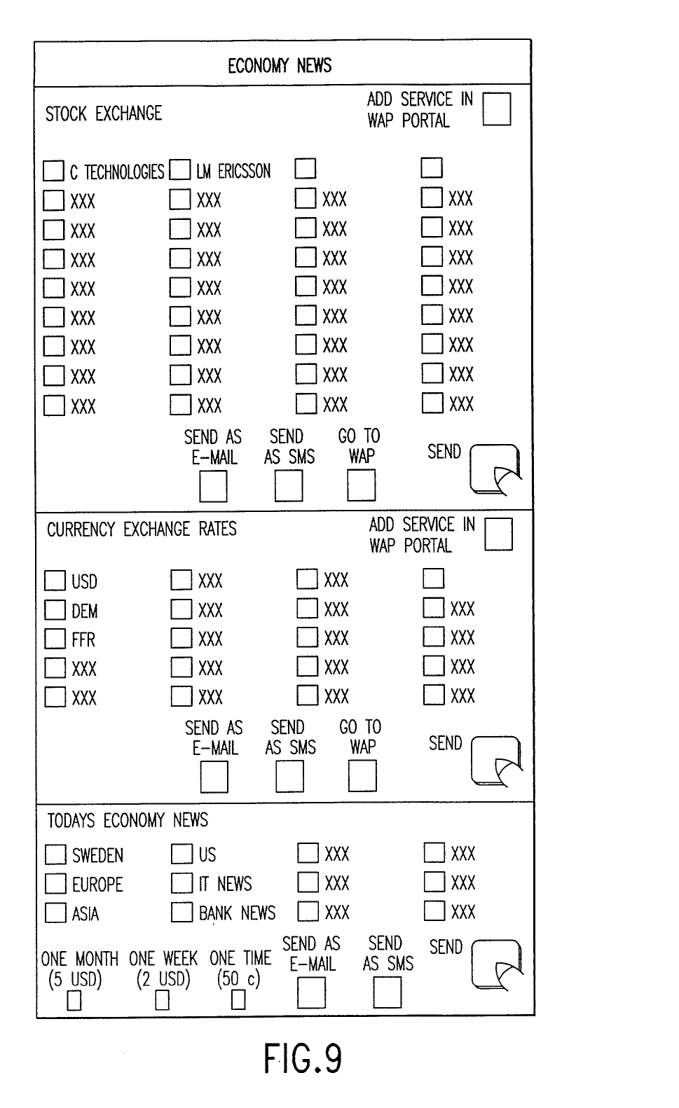

FIGS. 8-10 illustrate additional possible catalog pages to be employed in the system and method of the present application. FIG. 8 illustrates the ordering of digital paper products and the possibility of either ticking boxes to perform shipping and billing functions based simply on the pen ID, or alternatively, to add different customer information, for example when the pen is utilized by a person other than the pen's registered owner. FIG. 9 illustrates another example of alternative services. Note that while these services may be without additional charge, other than the periodic or per use digital pen use services, they may also include pay services, where a subscription to this service is charged but where the service may be periodically accessed without charges in addition to the periodic or per use digital pen use services. An example of this is “today's economic news” in the example of FIG. 9.

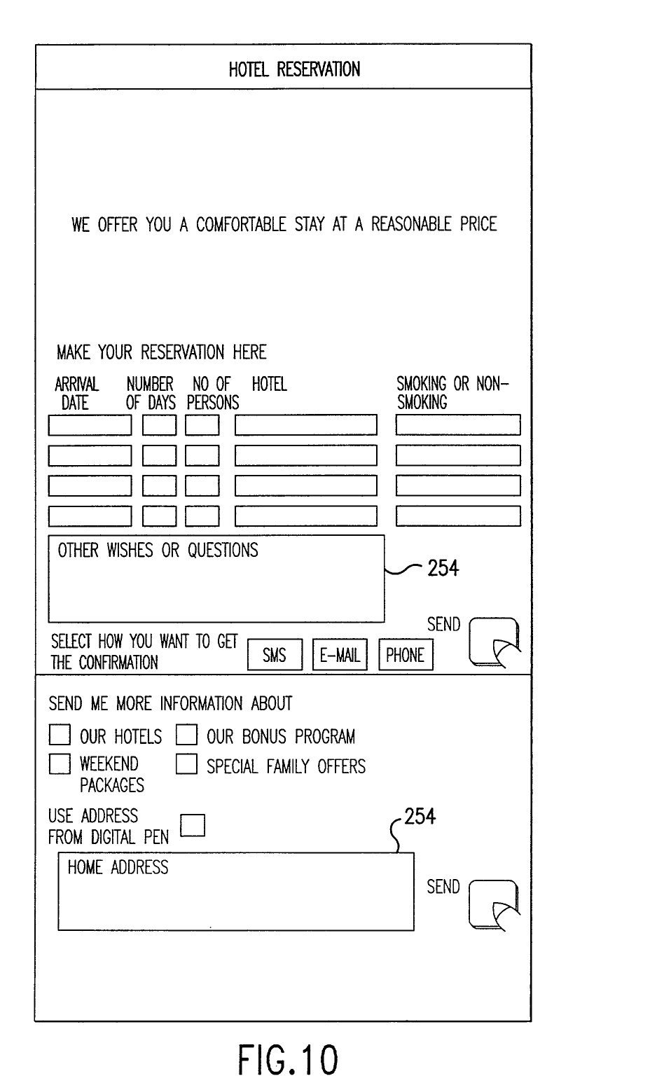

FIG. 10 shows an additional example of the issuance of an inquiry. In this example, the customer may request additional information about hotels, the hotel bonus program, weekend packages, or other goods or service items. In the examples of FIGS. 8, 10 a message may be included on the paper, by writing in a position-defining indicia-bearing area 252, 254 in addition to other Anoto functionality. Thus, the system of the present application is equally applicable to inquiry-based requests associated with fee based services.

### REFERENCE TO RELATED APPLICATIONS

Co-pending with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Image Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30, 2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, and U.S. Provisional Application No. 60/207,882, filed May 30, 2000; Data Form Having a Position-Coding Pattern Detectable by an Optical Sensor based on Swedish Application No. 0001236-9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 0000943-1, filed Mar. 21, 2000, and U.S. Provisional Application No. 60/207,880, filed May 30, 2000; Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000, and U.S. Provisional Application No. ______, filed Jan. 12, 2001; U.S. Provisional Application No. ______ entitled Communications Services Methods and Systems, filed Mar. 21, 2001; Method and Arrangment in a Digital Communication System based on Swedish Application No. 0102232-6, filed Jun. 25, 2001; Communication Protocol based on Swedish Application No. 0102418-1, filed Jul. 5, 2001, and U.S. Provisional Application No. ______ filed Jul. 10, 2001; Method and System for Communications Service Revenue Collection based on U.S. Provisional Application No. 60/281,786, filed Apr. 6, 2001.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

It should be understood that the catalog ordering system of the present invention as well as the method of marketing digital pen services through the use of a catalog advertising good and/or service items may be modified as would occur to one of ordinary skill in the art. In this light, it should be understood that the spirit and scope of the present application should not be limited by the disclosure of the present application, the scope of the present invention being limited solely by the appended claims. It should also be understood that modification of the invention may be made as would occur to one of ordinary skill in the art.

What is claimed:

1. A system for filling orders for items listed in a catalog and requested by customers using a code reading wand to scan item identifying indicia in said catalog, the catalog including items from plural suppliers and the wand generating a wand identifying code, the system comprising:
a processor receiving an indication of the items to be ordered by the customer through interaction of a code reading wand used as a catalog order transmitter with item defining indicia, the code reading wand outputting order particular information identifying the item or items to be ordered, the order particular information being received over a communication channel from the code reading wand;
a data base located remotely from at least some of said plural suppliers, the data base containing supplier specific information concerning each of the plural suppliers advertising products in the catalog, said system using the data base to convert the order particular information received by said processor into supplier specific order information identifying the supplier to supply each of the items to be ordered by the order, said data base providing routing information enabling the supplier specific order information to be routed to the said supplier selling those items;
said processor causing the routing of the supplier specific order information to one or more of said plural suppliers associated with said order particular information, the transmitted supplier specific order information including information identifying the items from the catalog order to be shipped by that supplier as well as customer specific information related to the order, the supplier specific order information allowing the supplier to ship the order directly to the customer.

2. The system of claim 1 wherein said processor is provided within a wand lookup server and receives the wand identifying signal from said code reading wand as well as information related to items to be ordered and identifies the suppliers of each item in the order and provides this information to the code reading wand, the code reading wand sending supplier specific order information and customer specific information to each supplier of ordered items.

3. The system of claim 1 wherein said wand has plural users, the system further comprising:
a code reading wand lookup server, the code reading wand lookup server receiving a wand service request from the code reading wand including the wand identification code, the wand lookup server identifying that the wand is requesting placement of a catalog order and the desired application for said wand and forwarding the wand the address of a catalog server;
said wand transmitting said catalog order specific information and said customer specific information to said processor acting as a catalog server and accessing said database to supply supplier specific order information and customer specific information to each supplier associated with an ordered item.

4. The system of claim 2 wherein said database includes customer specific information.

5. The system of claim 1 further comprising:
a code reading wand reading a said item identifying indicia, the code reading wand including a position indicating indicia sensor and a transmitter for communicating the order particular information, said wand transmitting a wand output signal;
a communications channel, receiving said wand output signal and transmitting it over said channel;
said processor receiving said wand output signal as a catalog order from said communications channel.

6. The system of claim 5 wherein the transmitter of the code reading wand is a Bluetooth protocol transmitter, said communications channel receiving the Bluetooth protocol from said code reading wand.

7. The system of claim 6 wherein said communication channel includes a Bluetooth receiver connected to a computer network.

8. The system of claim 6 wherein said communication channel includes a wireless communications path as a part thereof;
said communications channel including a wireless communication device, receiving said wand output signal, and re-transmitting said signal over the wireless communication path.

9. The system of claim 5 wherein said code reading wand is a digital pen, said digital pen reading a position defining background pattern from a code bearing surface.

10. The system of claim 9 wherein said code bearing surface is digital paper.

11. The system of claim 5 wherein said system further includes a catalog wherein said item defining indicia is a position defining indicia printed thereon.

12. The system of claim 11 wherein said catalog is printed on digital paper printed with a position defining background dot pattern.

13. The system of claim 1 wherein said catalog includes order boxes imprinted with position defining indicia as said item identifying indicia, said database recording the position defined by the position defining indicia associated with each of said order boxes.

14. The system of claim 11 wherein said catalog is included within the sales packing of said digital pen at the time of initial sale.

15. The system of claim 1 wherein said wand is a digital pen intended for interaction with digital paper having a position defining pattern background as said item identifying indicia,
said digital pen sold to consumers being further used to access additional information encoded in one or more data sites, said system being billed to the user on a per use or periodic use charge,
said data base further including additional service routing information storing the location of computers having these additional services, the consumer being supplied these additional services from an additional services database.

16. The system of claim 1 wherein said customer information is stored in said data base and includes customer identification, customer shipping information, and customer billing information.

17. The system of claim 1 wherein said customer information is stored in said code reading wand.

18. The system of claim 1 wherein said items are goods or services to be sold or provided for a fee.

19. A method of promoting the use of code reading wands comprising:
a) advertising items offered by plural suppliers in a catalog having order boxes encoded with item identifying indicia imprinted in the catalog and identifying each of the offered items;
b) selling a code reading wand and services associated therewith, the code reading wand having the capability of reading said item identifying indicia and selecting items offered in the catalog as well as performing other functions, the wand being capable of transmitting a wand identification code as well as order particular information identifying one or more items to be ordered or inquired about; the catalog orders providing initial functionality to the code reading wand, the code reading wand having functionality which may increase with increasing public wand purchase and use;
c) distributing the catalog in association with sale of the code reading wand to provide an initial use for the code reading wand and encourage wand use by the customer.

20. The method of claim 19 wherein said step c) is performed by enclosing the catalog in a single package with the code reading wand prior to wand sale in step b).

21. The method of claim 19 wherein said step c) is performed by sending a catalog to each customer in response to receipt of a warranty card.

22. The method of claim 19 wherein said step c) is performed by providing each customer of a wand with a subscription to a catalog or a periodic magazine including a catalog portion thereof.

23. The method of claim 19 wherein said method promotes the sale of code reading wands by promoting their use.

24. The method of claim 19 further comprising:
d) facilitating use by customers of said code reading wand by,
i) receiving a signal produced by the scanning of item identifying indicia within said catalog with the code reading wand employed by a customer as a catalog order transmitter including order particular information identifying the item or items to be ordered or inquired about,
ii) using a data base located remotely from at least some of said plural suppliers for converting the catalog order received in step i) into supplier specific order information representative of orders or inquiries to be routed to one or more of said plural suppliers and customer specific information, said data base containing contact information allowing the supplier specific order information to be transmitted to each selected supplier,
iii) transmitting supplier specific order information produced in step ii) to one or more of said plural suppliers associated with said order particular information received in said step i), the transmitted supplier specific order information including information identifying the items from the catalog order to be shipped by or inquiries to be answered by that supplier as well as customer specific information related to the order or inquiry, the supplier specific order information allowing the supplier to supply the order directly to the customer or respond directly to the customer inquiry.

25. The method of claim 19 wherein the services associated with the wand are wand use services, the method further comprising:
d) including additional services in the catalog, these services also having order boxes encoded with item identifying indicia imprinted in the catalog and identifying each of the additional services, the additional services being free to the user apart from the wand use services, the additional services encouraging the retention and review of the catalog, thereby increasing handling of the catalog and likelihood of orders or inquiries concerning fee based items therefrom.

26. The method of claim 19 wherein said method further comprises the step d) of funding the development of the catalog by collecting catalog preparation and advertising fees from said plural suppliers.

27. The method of claim 19 wherein said items are goods or services purchased or provided for a fee.

28. The method of claim 27 wherein the plural suppliers each provide a diverse type of goods or service.

29. The method of claim 24 further comprising:
d) charging the plural suppliers with a per response fee for each order or inquiry generated by interaction of the code reading wand with the catalog.

30. The method of claim 25 further comprising:
e) charging the plural suppliers with a per response fee for each order or inquiry generated by interaction of the code reading wand with the catalog.

31. The method of claim 19 further comprising:
d) identifying a relevant target market for a particular promotion of the code reading wand and services associated therewith and tailoring the content of the catalog to the relevant target market.

32. The method of claim 31 further comprising:
e) charging the plural suppliers with a per response fee for each order or inquiry generated by interaction of the code reading wand with the catalog.

33. The method of claim 19 wherein said code reading wand is a digital pen, said digital pen reading a position defining background pattern from a code bearing surface.

34. The method of claim 33 wherein said code bearing surface is formed from digital paper.

35. A method of promoting the use of code reading wands comprising:
a) distributing a catalog to a relevant market, the catalog being usable by reading item identifying indicia uniquely identifying items offered in the catalog, the item identifying indicia being intended to be scanned by a code reading wand, the code reading wand facilitating the generation of catalog order or inquiry information as well as being capable of performing other non-catalog order or inquiry functions, the wand transmitting a wand identification code as well as indicia specific information;
b) advertising various fee based good and/or service items in a catalog having order boxes encoded with item identifying indicia permanently imprinted on the catalog and identifying each of the offered items; the catalog orders providing initial functionality to the code reading wand; and
c) including additional services in the catalog, these services also having order boxes encoded with item identifying indicia permanently imprinted on the catalog and identifying each of the additional services, the additional services being free to the user apart from the wand use services, the additional services encouraging the retention and review of the catalog, thereby increasing handling of the catalog and likelihood of ordering or inquiring about fee based items advertised therein.

36. The method of claim 35 wherein said catalog advertises fee based items from plural suppliers, said method further including,
d) selling a code reading wand and fee based wand use services associated therewith to a customer, the code reading wand having functionality which may increase with increasing public code reading wand purchase and use;
the catalog being circulated in association with the sale of the code reading wand to provide an initial use for the code reading wand and to encourage wand use by the customer.

37. The method of claim 36 wherein said step d) is performed by enclosing the catalog in a single package with the code reading wand prior to wand sale in step b).

38. The method of claim 36 wherein said step d) is performed by handing out the catalog at a store distributing the pen.

39. The method of claim 36 wherein said step d) is performed by sending a catalog to each customer in response to receipt of a warranty card.

40. The method of claim 36 wherein said step d) is performed by providing each customer of a wand with a subscription to a catalog or a periodic magazine including a catalog portion thereof.

41. The method of claim 36 wherein said method promotes the sale of code reading wands by promoting their use.

42. The method of claim 37 wherein the catalog includes items offered by plural suppliers, the method further comprising
e) receiving a signal produced by scanning the item identifying indicia associated with the fee based items with the code reading wand, the code reading wand being employed by a user as a catalog order transmitter including order particular information identifying the item or items to be ordered;
f) using a data base located remotely from at least some of said plural suppliers for converting the catalog order received in step e) into supplier specific order information representative of orders or inquiries to be routed to one or more of said plural suppliers and customer specific order information, said data base containing contact information allowing the supplier specific order information to be transmitted to each selected supplier;
g) transmitting supplier specific order information produced in step f) to one or more of said plural suppliers associated with said order particular information received in said step e), the transmitted supplier specific order information including information identifying the items from the catalog order or inquiry to be shipped by that supplier as well as customer specific order information related to the order or inquiry, the supplier specific order information allowing the supplier to ship the order directly to the customer.

43. The method of claim 42 wherein said method further includes the step e) of funding the development of the catalog by collecting catalog preparation and advertising fees from said plural suppliers.

44. The method of claim 35 wherein said items are goods or services purchased or provided for a fee.

45. The method of claim 44 wherein the plural suppliers each provide a diverse type of goods or service.

46. The method of claim 42 further comprising:
h) charging the plural suppliers with a per response fee for each order or inquiry generated by interaction of the code reading wand with the catalog.

47. The method of claim 36 wherein said code reading wand is a digital pen, said digital pen reading a position defining background pattern from a code bearing surface.

48. The system of claim 47 wherein said code bearing surface is formed from digital paper.

49. A method of promoting the use of code reading wands comprising:
a) distributing a catalog to a relevant market, the catalog being usable by reading item identifying indicia permanently printed therein and uniquely identifying items offered in the catalog, the item identifying indicia being intended to be scanned by a code reading wand, the code reading wand facilitating the generation of catalog order or inquiry information as well as being capable of performing other non-catalog order functions, the wand transmitting a wand identification code as well as indicia specific information, the catalog promoting the use of the wand;
b) advertising various fee based good and/or service items available from plural suppliers in the catalog, the indicia permanently imprinted in the catalog identifying each of the offered items; the catalog orders providing initial functionality to the code reading wand; and
c) charging the plural suppliers with a per response fee for each order or inquiry generated by interaction of the code reading wand with the catalog.

50. The method of claim 49 further including:
d) including additional services in the catalog, these services also having order boxes encoded with item identifying indicia permanently imprinted on the catalog and identifying each of the additional services, the additional services being free to the user apart from the wand use services, the additional services encouraging the retention and review of the catalog, thereby increasing handling of the catalog and likelihood of ordering fee based items therefrom.

51. The method of claim 49 wherein said method further comprises:
d) printing the catalog for distribution in the relevant market;
e) charging at least some of the plural suppliers a catalog preparation or advertising fee associated with the inclusion of the suppliers products in the catalog.

52. The method of claim 49 wherein said method further comprises:
d) distributing the catalog in association with sale of the code reading wand to provide an initial use for the code reading wand and encourage wand use by the customer.

53. The method of claim 49 further comprising:
d) facilitating use by customers of said code reading wand by,
i) receiving a signal produced by the scanning of position-defining indicia as the item-identifying indicia within said catalog with the code reading wand employed by a customer as a catalog order transmitter including a wand identification code and order particular information identifying the item or items to be ordered or inquired about,
ii) using a data base located remotely from at least some of said plural suppliers for converting the catalog order received in step i) into supplier specific order information representative of orders or inquiries to be routed to one or more of said plural suppliers and customer specific information, said data base containing contact information allowing the supplier specific order information to be transmitted to each selected supplier,
iii) transmitting supplier specific order information produced in step ii) to one or more of said plural suppliers associated with said order particular information received in said step i), the transmitted supplier specific order information including information identifying the items from the catalog order to be shipped by or inquiries to be answered by that supplier as well as customer specific information related to the order or inquiry, the supplier specific order information allowing the supplier to supply the order directly to the customer or respond directly to the customer inquiry.

54. The method of claim 49 wherein said items are goods or services purchased or provided for a fee.

55. The method of claim 54 wherein the plural suppliers each provide a diverse type of goods or service.

56. The method of claim 53 wherein said wand identification code is associated in said database with the customer based on registration information provided by the user in association with the wand purchase.

57. The method of claim 49 wherein said code reading wand is a digital pen, said digital pen reading a position defining background pattern from a code bearing surface.

58. The system of claim 57 wherein said code bearing surface is formed from digital paper.

59. A method of ordering services comprising:
a) advertising items offered by plural suppliers in a catalog having order boxes encoded with item identifying indicia imprinted in the catalog and identifying each of the offered items;
b) receiving a signal produced by the scanning of item identifying indicia with a code reading wand employed by a customer as a catalog order transmitter and transmitting order particular information identifying the item or items to be ordered;
c) using a data base located remotely from at least some of said plural suppliers for converting the catalog order received in step b) into supplier specific order information representative of orders to be routed to one or more of said plural suppliers and customer specific information, said data base containing contact information allowing the supplier specific order information to be transmitted to each selected supplier;
d) transmitting supplier specific order information produced in step c) to one or more of said plural suppliers associated with said order particular information received in said step b), the transmitted supplier specific order information including information identifying the items from the catalog order to be shipped by that supplier as well as customer specific information related to the order, the supplier specific order information allowing the supplier to ship the order directly to the customer.

60. The method of claim 59 further comprising:
e) distributing the catalog in association with sale of the code reading wand to provide an initial use for the code reading wand and encourage wand use by the customer.

61. The method of claim 60 wherein steps b)-d) are wand use services provided for a per use or periodic fee to the customer, the method further comprising:
f) including additional services in the catalog, these services also having order boxes encoded with item identifying indicia imprinted in the catalog and identifying each of the additional services, the additional services being free to the user apart from the wand use services, the additional services encouraging the retention and review of the catalog, thereby increasing handling of the catalog and likelihood of orders or inquires concerning fee based items therefrom.

62. The method of claim 60 wherein said method further comprises the step f) of funding the development of the catalog by collecting catalog preparation and advertising fees from said plural suppliers.

63. The method of claim 59 wherein said items are goods or services purchased or provided for a fee.

64. The method of claim 63 wherein the plural suppliers each provide a diverse type of goods or service.

65. The method of claim 63 further comprising:
d) charging the plural suppliers with a per response fee for each order generated by interaction of the code reading wand with the catalog.

66. The method of claim 65 wherein said wand identification code is associated in said database with the customer based on registration information provided by the user in association with the wand purchase.

67. The method of claim 59 wherein said code reading wand is a digital pen, said digital pen reading a position defining background pattern from a code bearing surface.

68. The system of claim 67 wherein said code bearing surface is formed from digital paper.
